(19) United States
(12) Patent Application Publication
(10) Pub. No.: US 2023/0096430 A1
(43) Pub. Date: Mar. 30, 2023

(54) SPEECH RECOGNITION SYSTEM FOR TEACHING ASSISTANCE

(71) Applicant: National Yang Ming Chiao Tung University, Hsinchu (TW)

(72) Inventors: Sin Horng Chen, Hsinchu (TW); Yuan Fu Liao, Hsinchu (TW); Yih Ru Wang, Hsinchu (TW); Shaw Hwa Hwang, Hsinchu (TW); Bing Chih Yao, Hsinchu (TW); Cheng Yu Yeh, Hsinchu (TW); You Shuo Chen, Hsinchu (TW); Yao Hsing Chung, Hsinchu (TW); Yen Chun Huang, Hsinchu (TW); Chi Jung Huang, Hsinchu (TW); Li Te Shen, Hsinchu (TW); Ning Yun Ku, Hsinchu (TW)

(21) Appl. No.: 17/484,023

(22) Filed: Sep. 24, 2021

(51) Int. Cl. G09B 21/00; G10L 15/26; G10L 21/10

(52) U.S. Cl. CPC G09B 21/009; G10L 15/26; G10L 21/10; G10L 2021/065

(57) ABSTRACT

The present invention provides a speech recognition system for teaching assistance, which provides caption service for the hearing impaired. This system includes a speaker and a automatic speech recognition (ASR) classroom server, a listener-typist and a computer, a hearing impaired and a live screen, all are in the same classroom. Connect the ASR classroom server, the computer and the live screen with a local area network. The speaker's audio is sent to the ASR classroom server by a microphone for being converted into text caption, and then the text caption is sent to the live screen of the hearing impaired together with the speaker's audio so that the hearing impaired can read the text caption spoken by the speaker. The text caption can be corrected by the listener-typist to make it completely correct.

### FIELD OF THE INVENTION

The present invention relates to a speech recognition system for teaching assistance, and more particularly of using a automatic speech recognition (ASR) classroom server and a listener-typist to provide caption service in classroom for the hearing impaired.

### BACKGROUND OF THE INVENTION

In ordinary classrooms, hearing impaired students have problems in class, because there is no monitor to directly display the captions of the teacher's lecture content. In various presentations and conferences, the hearing impaired cannot participate because there is no monitor to directly display captions.

Therefore, setting up captions for the hearing impaired that can show what the teacher or speaker says is a great boon for the hearing impaired.

Nowadays, some conferences use a listener-typist to type the content of the speaker with the computer on the spot and display it on the computer screen as captions, so that the hearing impaired can understand the situation on the spot. However, the listener-typist spends a lot of energy listening to the content of the speaker. Once the working hours are too long, there may be missed sentences and typos. Therefore, a more complete listener-typist solution must be provided.

### SUMMARY OF THE INVENTION

The object of the present invention is to provide a speech recognition system for teaching assistance, to provide caption service for the hearing impaired in the classroom. The contents of the present invention are described as below.

This system includes a speaker and a automatic speech recognition (ASR) classroom server, a listener-typist and a computer, a hearing impaired and a live screen, Connect the ASR classroom server, the computer and the live screen with a local area network. All are in the same classroom.

The automatic speech recognition (ASR) classroom server includes: a microphone input; an open source speech recognition toolkit for speech recognition and signal processing; a web server is responsible for providing the interface of the web page, which is transmitted to the computer and the live screen through the HTTP protocol; a recording module is used for the playback function of the listener-typist.

The audio of the speaker is sent by the microphone input to the ASR classroom server for being converted into text caption, then the text caption is sent to the live screen of the hearing impaired and the computer of the listener-typist together with the speaker's audio, so that the hearing impaired can read the text caption spoken by the speaker. If the text caption has some errors, the listener-typist can correct immediately on the computer.

### BRIEF DESCRIPTION OF THE DRAWINGS

FIG. 1 shows schematically the basic structure of the speech recognition system for teaching assistance according to the present invention.

FIG. 2 shows schematically the contents of the automatic speech recognition (ASR) classroom server according to the present invention.

FIG. 3 shows schematically the procedures to generate the text caption by the automatic speech recognition (ASR) classroom server according to the present invention.

FIG. 4 shows schematically the operation of the listener-typist according to the present invention.

FIG. 5 shows schematically the hearing impaired obtains the web server page of the ASR classroom server for reading according to the present invention.

### DETAILED DESCRIPTIONS OF THE PREFERRED EMBODIMENTS

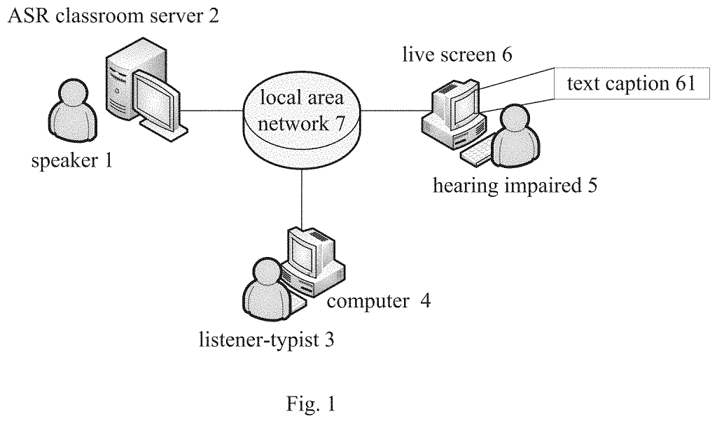

FIG. 1 describes the basic structure of the speech recognition system for teaching assistance according to the present invention. The speaker 1 and the ASR classroom server 2 are at the same place. The ASR classroom server 2, the computer 4 of the listener-typist 3 and the live screen 6 of the hearing impaired 5 are connected by a local area network7. All are in the same classroom.

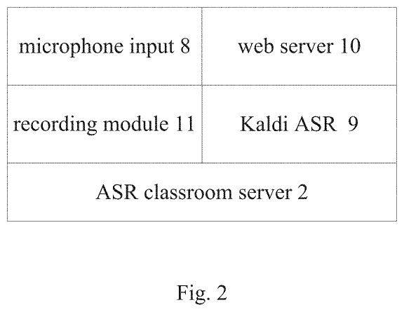

FIG. 2 describes the contents of the automatic speech recognition (ASR) classroom server 2 according to the present invention, in which the microphone input 8 is the lecturing contents of the speaker 1 collected by a microphone.

The ASR classroom server 2 uses an open source speech recognition toolkit Kaldi ASR 9 for speech recognition and signal processing, which can be obtained freely under Apache License v2.0.

The ASR classroom server 2 has to be equipped with a web server 10, which is an interface for providing the web and for being delivered to clients through HTTP (web browser). The clients mean the computer 4 and the live screen 6. The ASR classroom server 2 has a recording module 11 for being used by the listener-typist 3 to conduct a playback function.

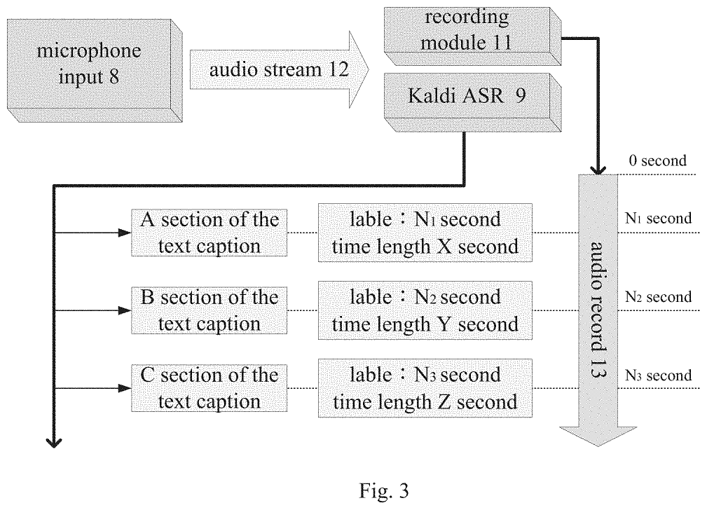

Referring to FIG. 3, the text caption generating process of the ASR classroom server 2 according to the present invention is described. The audio of the speaker 1 is sent by the microphone input 8 of the ASR classroom server 2 for being formed into an audio stream 12, and inputted into the Kaldi ASR 9 and the recording module 11 respectively. The recording module 11 will record the audio stream 12 into an audio record 13 based on the time. When the Kaldi ASR 9 receives the audio stream 12, the audio stream 12 will be converted into text caption. Each section of the text caption will be added with a label as shown in FIG. 3. The label will describe what second of the audio record 13 that the section of the text caption is corresponding to, and how long it is. These text captions and labels thereof will be shown on the web page of the web server 10 for being sent to the computer 4 and the live screen 6 through the local area network 7.

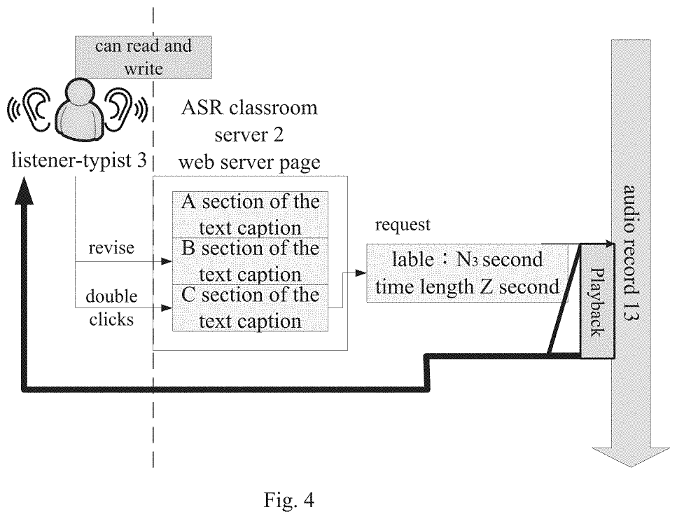

Referring to FIG. 4, the operation of the listener-typist 3 in the classroom according to the present invention is described. The listener-typist 3 in the classroom logins in the page of the web server 10 of the ASR classroom server 2 through the computer 4 and the local area network 7 for reading the text caption and for listening the audio of the speaker 1.

The listener-typist 3 is set up to have the authority of reading and writing in the ASR classroom server 2 so as to be capable to revise the text generated by the Kaldi ASR 9 in the web server 10. Each section of the text has a label, for example, if the listener- typist 3 clicks two times on the C section of the text, the web server 10 will follow the instructions of the related label to ask the audio record 13 to playback the paragraph of the N3 second with time length Z seconds, so that the listener-typist 3 can recognize the contents spoken by the speaker 1 for amending the text.

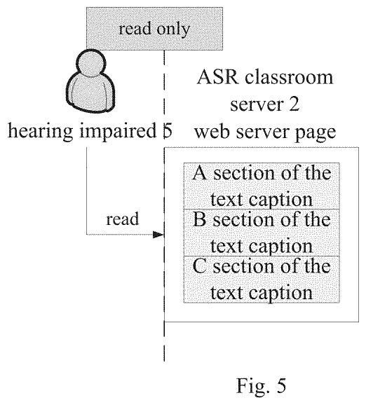

Referring to FIG. 5, The speaker 1 uses the ASR classroom server 2 to output the audio of the speaker 1 together with the text caption of the web server 10 to the live screen 6 of the hearing impaired 5, so that the hearing impaired 5 can read the text caption 61 (see FIG. 1) on the live screen 6, but only have the authority of reading.

The text caption 61 on the live screen 6 reading by the hearing impaired 5 is a convertion of the lecturing contents of the speaker 1 by Kaldi ASR 9, usually more than 98% are correct. If the listener- typist 3 finds some. errors, the listener-typist 3 can correct it. The hearing impaired 5 can store the text caption 61 after the class, and the text caption 61 stored is the perfect edition amended by the listener-typist 3.

The scope of the present invention depends upon the following claims, and is not limited by the above embodiments.

What is claimed is:

1. A speech recognition system for teaching assistance, comprising:
a speaker and a automatic speech recognition (ASR) classroom server, a listener-typist and a computer, a hearing impaired and a live screen; connect the ASR classroom server, the computer and the live screen with a local area network, all are at a same classroom; an audio of the speaker is sent by a microphone to the ASR classroom server for being converted into a text caption, and then the text caption is sent to the live screen of the hearing impaired together with the speaker's audio through the local area network, so that the hearing impaired can read the text caption spoken by the speaker; if the listener-typist finds some errors in the text caption, the listener-typist can correct it on the computer.

2. The speech recognition system for teaching assistance according to claim 1, wherein the ASR classroom server comprising:
a microphone input to receive a lecturing content of the speaker;
an open source speech recognition toolkit for conducting speech recognition and signal processing;
a web server is responsible for providing a web page for being transmitted to the computer and the live screen through an HTTP protocol;
a recording module is used for a playback function of the listener-typist.

3. The speech recognition system for teaching assistance according to claim 2, wherein the text caption generating process of the ASR classroom server comprising steps as below:
the microphone input receives the lecturing content of the speaker to form an audio stream, and being inputted into the open source speech recognition toolkit and the recording module respectively;
the recording module records the audio stream into an audio record based on the time;
after the open source speech recognition toolkit receives the audio stream, the audio stream will be converted into a text caption, each section of the text caption will be added with a label, the label will describe what second of the audio record that the section of the text caption is corresponding to, and how long it is; the text caption and label thereof will be shown on a web page of the web server for being sent to the computer and the live screen through the local area network.

4. The speech recognition system for teaching assistance according to claim 3, wherein the listener-typist logins in the web server of the ASR classroom server through the local area network for reading the text caption and listening the audio of the speaker; the listener-typist is set up to have the authority of reading and writing in the ASR classroom server so as to be capable to revise the text caption generated by the open source speech recognition toolkit in the web server.

5. The speech recognition system for teaching assistance according to claim 2, wherein the open source speech recognition toolkit is Kaldi ASR, which can be obtained freely under Apache License v2.0.
